(19) United States
(12) Patent Application Publication
(10) Pub. No.: US 2026/0221071 A1
(43) Pub. Date: Jul. 30, 2026

(54) REDUCING SCREEN FLICKER USING A CONCEALED ROLLING PATTERN

(71) Applicant: Microsoft Technology Licensing, LLC, Redmond, WA (US)

(72) Inventors: Xuming DENG, Shenzhen (CN); Muhammad Daniel Sun Bin ABDULLAH, Suzhou (CN)

(21) Appl. No.: 19/143,344

(22) PCT Filed: Jan. 29, 2023
(86) PCT No.: PCT/CN2023/073657

§ 371 Date: Jun. 25, 2025

(51) Int. Cl. G09G 3/20; G09G 3/34; G09G 3/36

(52) U.S. Cl. CPC G09G 3/2092; G09G 3/3406; G09G 3/36; G09G 2320/0247; G09G 2320/046; G09G 2330/021; G09G 2340/0435; G09G 2360/144

(57) ABSTRACT

Methods, systems and computer program products are provided for reducing screen flicker using a concealed rolling pattern. Field application of a concealable rolling pattern (e.g., alternating electric field), causing liquid crystal module pixels to display alternating patterns, may increase mobile ion diffusion (e.g., release accumulated charges), thereby reducing screen flickering and image burn-in. A rolling pattern may be applied in a low power mode (e.g., standby, sleep, off), with backlight off, and with ambient lighting below a threshold or a concealed display (e.g., lid closed). A concealed rolling pattern may be stopped based on a detected transition to a full power mode, rolling pattern timer expiration, ambient light above the threshold while the display is viewable, removal of a power supply and/or battery power below a threshold. A transition to full power may delay powering on the backlight, e.g., to allow multiple frames of black video for the display panel.

### BACKGROUND

Screen flickering and image burn-in is a concern for (e.g., laptop or tablet) computer liquid crystal display (LCD) panels. Screen flickering and image burn-in may occur, for example, when static images are displayed for a long time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided for reducing screen flicker using a concealed rolling pattern. Field application of a concealable rolling pattern (e.g., an alternating electric field) to cause liquid crystal module (LCM) pixels to display alternating black and white patterns may increase mobile ion diffusion, reducing screen flickering and image burn-in, which may be more common when static images are refreshed less frequently. In response to an indication that a computing device associated with the display panel is in a low power mode (e.g., standby, sleep, off), a computing device (e.g., a system controller interfaced with an LCM) may turn off the backlight for the display panel, determine that ambient lighting is below a threshold or that the display panel is concealed (e.g., lid closed), and release charges accumulated in the display panel (e.g., using the rolling pattern) while the computing device remains in a low power mode and while the ambient lighting remains below the threshold or while the display panel is concealed. The release of charges accumulated in the display panel may be stopped based on detection of one or more events, such as transitioning from the low power mode to a full power mode; receiving an indication that a timer for application of the rolling pattern has expired; determining that ambient light is above the threshold while the display panel is not concealed (e.g., lid not closed); or detecting an absence of a power supply or that a battery for the computing device is below a threshold. Upon receiving an indication to transition from the low power mode to a full power mode, a computing device may stop application of the rolling pattern to pixels in the display panel; and delay powering on the backlight after stopping application of the rolling pattern to pixels in the display panel. The delay may comprise a time for application of at least two frames of black video to the display panel.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 illustrates a block diagram of an example computing device for reducing screen flicker using a concealed rolling pattern, according to an embodiment.

FIG. 2 illustrates an example of a rolling pattern, according to an embodiment.

FIG. 3 illustrates an example of configuring variables for application of a concealed rolling pattern, according to an embodiment.

FIG. 4 illustrates an example of applying a concealed rolling pattern, according to an embodiment.

FIG. 5 illustrates an example of interrupting a concealed rolling pattern, according to an embodiment.

FIG. 6 illustrates an example of powering-on a display with a delay during a concealed rolling pattern to maintain concealment, according to an embodiment.

FIG. 7 illustrates a flowchart of an example method for reducing screen flicker using a concealed rolling pattern, according to an example embodiment.

FIG. 8 shows a block diagram of an example computing device that may be used to implement example embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

As noted in the Background Section, above, screen flickering and image burn-in is a concern for (e.g., laptop or tablet) computer liquid crystal display (LCD) panels. Screen flickering and image burn-in may occur, for example, when static images are displayed for a long time.

Methods, systems and computer program products are provided for reducing screen flicker using a concealed rolling pattern. Field application of a concealable rolling pattern (e.g., an alternating electric field) to cause liquid crystal module (LCM) pixels to display alternating black and white patterns may increase mobile ion diffusion, reducing screen flickering and image burn-in, which may be more common when static images are refreshed less frequently. In response to an indication that a computing device associated with the display panel is in a low power mode (e.g., standby, sleep, off), a computing device (e.g., a system controller interfaced with an LCM) may turn off the backlight for the display panel, determine that ambient lighting is below a threshold or that the display panel is concealed (e.g., lid closed), and release charges accumulated in the display panel (e.g., using the rolling pattern) while the computing device remains in a low power mode and while the ambient lighting remains below the threshold or while the display panel is concealed. The release of charges accumulated in the display panel may be stopped based on detection of one or more events, such as transitioning from the low power mode to a full power mode; receiving an indication that a timer for application of the rolling pattern has expired; determining that ambient light is above the threshold while the display panel is not concealed (e.g., lid not closed); or detecting an absence of a power supply or that a battery for the computing device is below a threshold. Upon receiving an indication to transition from the low power mode to a full power mode, a computing device may stop application of the rolling pattern to pixels in the display panel; and delay powering on the backlight after stopping application of the rolling pattern to pixels in the display panel. The delay may comprise a time for application of at least two frames of black video to the display panel.

Screen flickering and image burn-in is a concern for (e.g., laptop or tablet) computer liquid crystal display (LCD) panels. A panel self-refresh (PSR) function may be enabled to conserve power for static display content. For example, a display panel may be refreshed with a reduced refresh rate (e.g., less than 30 Hz) while displayed content is static. This power conservation feature may increase a risk of screen flickering and image burn-in, especially when static images are displayed for a long time.

Screen flicker may occur due to impurity ions in liquid crystal accumulating on an alignment layer (e.g., polyimide). Accumulated impurity ions may generate a residue electric field and cause an imbalance between positive and negative frames, which may generate a luminance change when switching between positive and negative driving polarity.

Computing devices (e.g., laptops, tablets) are often returned for service due to flicker and/or burn-in, e.g., due to leaving a display on for a long time (e.g., weeks) without powering off and/or showing a static image for a long time. Most flicker may be eliminated, for example, by powering a device off for a long time (e.g., two weeks) and/or by running a rolling pattern for a shorter time (e.g., two hours).

The accumulated charge and other display defects introduced by accumulated charge may be reduced or eliminated, for example, by field application of a rolling pattern to a display. An alternating electric filed induced when a panel displays alternating white and black patterns can increase the diffusion of mobile ions, e.g., make the mobile ions move more quickly back to liquid crystal.

For example, a rolling pattern may remove accumulated charge inside a Liquid Crystal Module (LCM) so that the device may be in flicker free condition each time a user powers up the device. Routine application of a rolling pattern may allow use of a lower refresh rate (e.g., less than 20 Hz) for static images, which may further increase battery life and reduce carbon emissions.

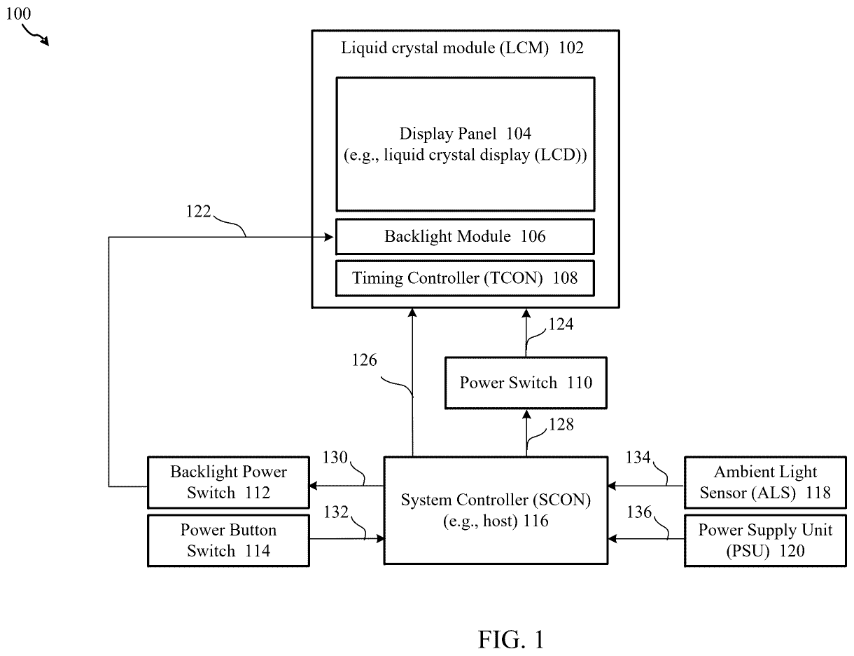

Embodiments may be implemented in a variety of systems/environments. For example, FIG. 1 illustrates a block diagram of an example computing device for reducing screen flicker using a concealed rolling pattern, according to an embodiment.

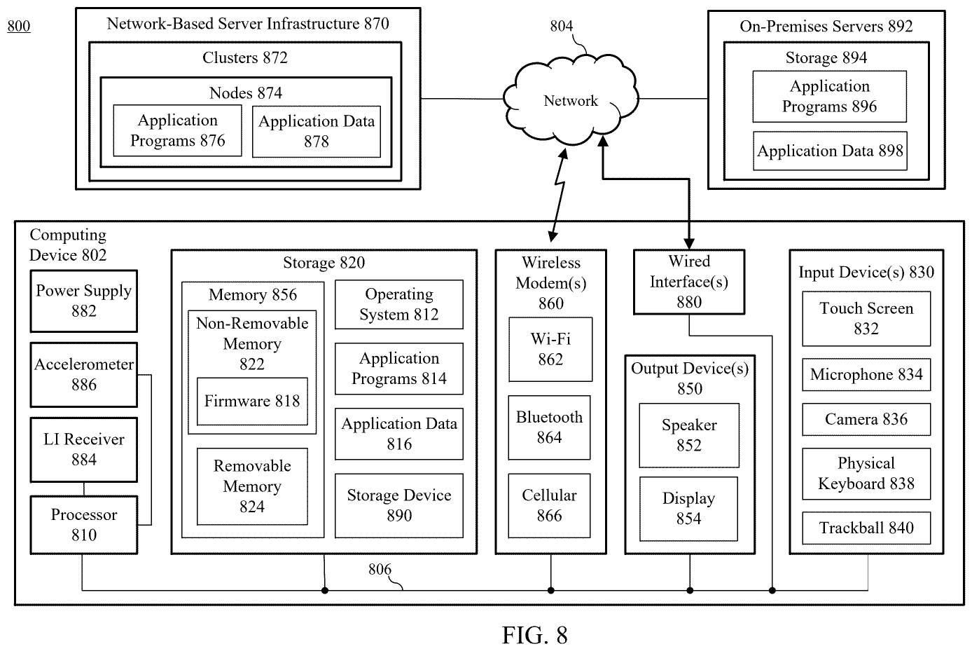

With reference to FIG. 1, example computing device 100 may be any computing device (e.g., any combination of hardware, software, and firmware). Another example computing device with example features is presented in FIG. 8. Example computing device 100 and 802 present several of many possible examples of computing devices. In various implementations, computing devices may comprise example components illustrated in FIG. 1, FIG. 8, and other additional or alternative devices not expressly illustrated.

Example computing device 100 may comprise a computing device utilized by one or more users (e.g., individual users, family users, enterprise users, governmental users, administrators, hackers, etc.) generally referenced as users. Computing device 100 may comprise one or more applications, operating systems, virtual machines (VMs), storage devices, etc., that may be executed, hosted, and/or stored therein or via one or more other computing devices (e.g., via network(s), which are not shown). Computing device 100 may be any type of stationary or mobile computing device, including a mobile computer or mobile computing device (e.g., a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server. An example computing device with example features is presented in FIG. 8.

Computing device 100 may have a computing environment. A computing environment may be any computing environment (e.g., any combination of hardware, software and firmware). Computing device 100 may execute one or more processes in a computing environment. A process is any type of executable (e.g., binary, program, application) that is being executed by a computing device. For example, computing device 100 may execute instructions (e.g., in a software or firmware) and/or execute in hardware application of a concealed rolling pattern and/or a user interface in which a user may configure or customize application of a concealed rolling pattern to reduce or minimize screen flicker and/or image burn-in.

As shown in FIG. 1, computing device 100 includes liquid crystal module (LCM) 102, power switch 110, backlight power switch 112, power button switch 114, system controller (SCON) 116, ambient light sensor (ALS) 118, and power supply unit (PSU) 120.

Liquid crystal module (LCM) 102 may include a liquid crystal display (LCD) and display control circuitry. For example, LCM 102 may include display panel 104, backlight module 106 and timing controller (TCON) 108.

Display panel 104 may display images to a user of computing device 100. Display panel 104 may be lit by backlight module 106 and controlled by TCON 108. Display panel 104 may be a touch screen display panel. Display panel 104 may comprise any type of LCD panel, such as a twisted nematic (TN) panel, a vertical alignment (VA) panel, a plane to line switching (PLS) panel, an advanced hyper-viewing angle (AHVA) panel, etc. LCD panels may be passive matrix or active matrix LCD panels, such as thin-film-transistor (TFT) panels, e.g., including in-plane switching (IPS) panels, O-film panels, multi-domain vertical alignment (MVA) panels, advanced fringe field switching (AFFS) panels, etc.

Display panel 104 may comprise multiple layers, such as light diffuser(s), light guide layer(s), polarizer layer(s), pixel electrode (e.g., thin film transistor (TFT)) layer, glass substrate layers, color filter layer, etc.

Backlight module 106 may provide lighting behind display panel (e.g., LCD) 104. For example, backlight module 106 may include (e.g., LED) edge lighting or an array of lights and a light pipe that illuminate the entire display panel 104. Control signals to electrodes for each pixel on display panel 104 control liquid crystal blockage of the backlight by the liquid crystals.

An LCD panel includes liquid crystals that may be controlled to change their orientation to block or pass backlight produced by backlight module 106. Liquid crystal control signals may be applied to transparent conductors formed on a glass layer adjacent to (e.g., and confining) the liquid crystal. For example, an LCD panel may include millions of crystals that may be controlled (e.g., by electric signals applied to subpixel electrodes) to allow light to pass (e.g., partially or completely) or not pass through the crystals and through red, green and blue (RGB) subpixels in an RGB color filter formed at each display pixel. Display panel 104 may display black when all crystals block the backlight. Display panel 104 may display white when the crystals do not block any backlight. Varying signals for subpixels may produce different colors and intensities for each pixel.

Timing controller (TCON) 108 may control signal drivers (e.g., for subpixel control) of display panel 104. A graphics processing unit (GPU) (not shown) may transform video data (e.g., encoded video signals) into individual pixels and frames. TCON 108 may apply corrections (e.g., color, brightness corrections) to frames generated by the GPU. In some examples, a GPU may be integrated with a central processing unit (CPU). TCON 108 may provide respective portions of an image (e.g., to be displayed) to signal drivers for various arrays of subpixels in the display based on the timing configured for display panel 104.

TCON 108 may be configured to control a refresh rate for images displayed by display panel 104. The refresh rate may be reduced, for example, to save power, which may extend battery life. For example, TCON 108 may implement panel self-refresh (PSR), which may use a frame buffer to maintain a display image without receiving and processing video data from the GPU. A GPU may enter a low-power state for a still image or portions of a video frame that do not need a display update. PSR may increase the risk of occurrence of flicker and/or screen burn-in.

TCON 108 may have a built in self-test (BIST) mode, which may be used to test display panel 104. A BIST mode, or other mode, may be configured (e.g., with a rolling pattern BIST mode) to apply a rolling pattern to display panel 104, for example, to increase mobile ion diffusion, release charges accumulated in the display panel, and reduce the likelihood of screen flickering and image burn-in. Application of a BIST mode rolling pattern may be controlled (e.g., turned on/off, selected/deselected, enabled/disabled) by SCON 116, for example, via BIST control signal 126. SCON 116 may coordinate other signaling, such as control of power to backlight module 106, e.g., to conceal application of a rolling pattern to display panel 104. TCON 108 and/or SCON 116 may (e.g., be configured to) control application of a rolling pattern BIST mode by TCON 108. Application of a rolling pattern BIST mode may be based on custom and/or default settings, automatic, manual, periodic, and/or event driven run times.

Power switch 110 may provide power to LCM 102 via a power conductor 124. Power switch 110 may be controlled (e.g., enabled and disabled) by SCON 116, for example, using an LCM power enable signal 128.

Backlight power switch 112 may provide power to backlight module 106 via a backlight power conductor 122. Backlight power switch 112 may be controlled (e.g., enabled and disabled) by SCON 116, for example, via a backlight power enable signal 130. Backlight power switch 112 may provide power to backlight module 106 if/when backlight power enable signal 130 is enabled. Backlight power switch 112 may cut off power to backlight module 106 if/when backlight power enable signal 130 is disabled.

Power button switch 114 may provide a user interface button for a user to power-up and power-down computing device 100. Power-down may include one or more low power modes, such as standby, sleep, and OFF. For example, a short press of power button switch 114 may place computing device 100 in sleep mode while a long press of power button switch 114 may place computing device in a shutdown or OFF state. Computing device 100 may also enter a standby or sleep mode, for example, after a timer reaches a threshold of time without any user interaction with computing device 100. Computing device 100 may be configured (e.g., via SCON 116) to conserve power by placing all or portions of computing device 100, such as LCM 102 in a low power mode. A power selection signal 132 may be provided to SCON 116 to indicate the selected power state of computing device 100.

Ambient light sensor (ALS) 118 may sense (e.g., generate a signal indicating) the amount of ambient light in the vicinity of computing device 100. ALS 118 may provide an ambient lighting signal 134 to SCON 116.

Power supply unit (PSU) 120 may provide power to computing device 100. Power supplied through PSU 120 may be battery power and/or power supplied through an alternating current (AC) adapter plugged into an AC outlet. PSU 120 may indicate the type of power available and/or battery life remaining to SCON 116, for example, via a power detection signal 136.

System controller (SCON) 116 may be referred to as a host controller. SCON 116 may be located on a motherboard of computing device 100. SCON 116 may comprise or may be in communication with, for example, a central processing unit (CPU) in computing device 100. Example computing system 100 shows an example of a communication interface between TCON 108 and SCON 116. SCON 116 may receive input, such as power selection signal 132 from power button switch 114, ambient lighting signal 134 from ALS 118, and power detection signal 136 from PSU 120, e.g., among other inputs (not shown). SCON 116 may use the inputs to make determinations, generate and provide control signals, such as LCM power enable signal 128 provided to power switch 110, backlight power enable signal 130 provided to backlight power switch 112, and BIST control signal 126 provided to TCON 108.

SCON 116 and/or TCON 108 may be configured to control application of a rolling pattern to display panel 104. Application of a rolling pattern may vary among implementations. In some examples, application of a rolling pattern may be concealed, such as if/when computing device 100 is in a low power mode (e.g., standby, sleep, OFF), as may be indicated by power selection signal 132, if backlight module 106 is powered off, and if display panel 104 is concealed and/or ambient light is below a threshold. In some examples, application of a rolling pattern may be applied only when it would not use up limited power, such as if/when PSU 120 indicates the computing device is receiving power from an AC outlet. Such an approach can advantageously preserve battery power of the computing device by prohibiting the application of the rolling pattern when the computing device is decoupled from the AC outlet. In some examples, application of a rolling pattern may be applied when it would not use battery power below a threshold, e.g., 80%. This can also beneficially preserve battery power.

SCON 116 may, e.g., if/when zero or more preconditions are satisfied, implement a procedure to instruct TCON 108 to apply a rolling pattern to display panel 104. In some examples, SCON 116 may begin a rolling pattern procedure if/when computing device 100 is connected to AC power and is in a low power mode (e.g., sleep or standby mode), e.g., after a user powered off computing device 100. SCON 116 may (e.g., first) turn off backlight module 106, and determine ambient lighting environment sensed by ALS 118. SCON 116 may assert BIST control signal 126 to TCON 108 to start a rolling pattern mode, for example, if the ambient environment light is dark enough (e.g., relative to a threshold). SCON 116 may keep main board power off while keeping power on for TCON 108 to apply the rolling pattern for a period of time. A user may be unaware that the rolling pattern is running in dark ambient light (e.g., or if display panel 104 isn't viewable, such as in a closed position) while backlight module 106 is off. A benefit of applying the rolling pattern in dark ambient light or if display panel 104 isn't viewable is that the rolling pattern will be applied in scenarios in which the user isn't likely to be using the computing device and/or viewing its display.

TCON 108 may apply a rolling pattern for a period of time (such as 30 minutes 60 minutes, 120 minutes). The period of time for the rolling pattern may be fixed or variable, default or custom (e.g., set by a user and/or based on computer system components). In some examples, a rolling pattern timer may vary based on a recent history of application of the rolling pattern. For example, if computing device already ran a rolling pattern for one hour on a given day and/or if display screen did not display static images at a reduced refresh rate for any significant time, the period of time may be reduced for application of a rolling pattern. By reducing the period of time for application of the rolling pattern in this manner, an embodiment can conserve power and limit the amount of time needed to occupy the display with the rolling pattern.

SCON 116 may de-assert BIST control signal 126 to TCON 108, for example, if ambient light rises above a threshold. TCON 108 may start to refresh display panel 104 with a black pattern to avoid user from seeing the rolling pattern on display panel 104.

SCON 116 may be configured to disable power switch 110 if PSU 120 reports that AC power has been removed, e.g., to save battery power in computing device 100.

A user may press power button switch 114 to power on computing device 100 while TCON 108 is still running a rolling pattern in BIST mode. SCON 116 may (e.g., first) de-assert BIST signal 126 to TCON 108 to stop the rolling pattern. TCON 108 may (e.g., next) send at least one black screen to display panel 104. SCON 116 may (e.g., next) turn on backlight power switch 112. The power on sequence may prevent a user from seeing the rolling pattern on display panel 104.

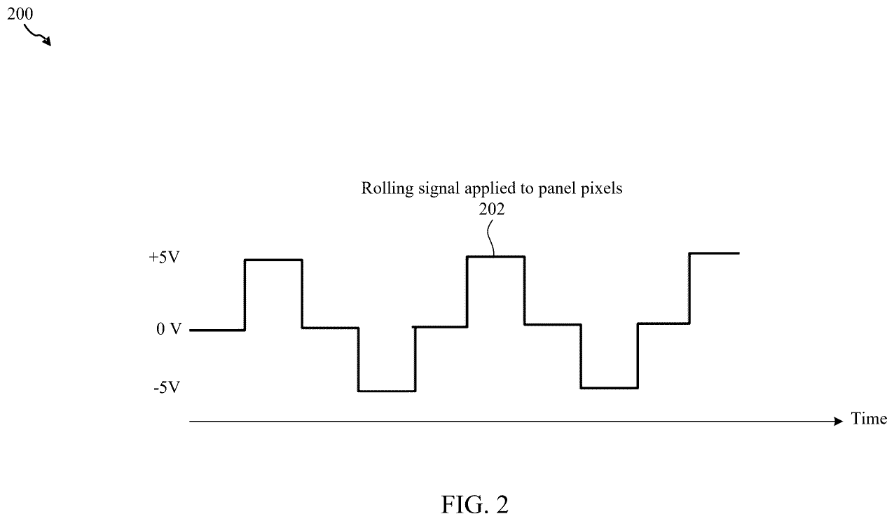

FIG. 2 illustrates an example 200 of a rolling pattern 202, according to an embodiment. As shown by example in FIG. 2, a rolling pattern may be a square wave electric field applied to each pixel in a panel. The rolling pattern may, for example, change from application of zero (0) Volts (V), positive five volts (+5V), to zero volts, to negative five volts (−5V) and repeat for each pixel in a panel for a period of time. The rolling pattern may remove DC accumulation inside the LCM panel. In an example, application of a rolling pattern may use approximately five Watts (5 W) of power for a tablet or laptop with a 13 inch screen/panel. In some embodiments, the rolling pattern may be applied (e.g., only) while the panel is powered by a power supply (e.g., alternating current (AC) power) and/or while remaining battery power remains above a threshold. A rolling pattern may be concealed, for example, by turning off the backlight before application of the rolling pattern when the screen is concealed (e.g., lid closed) and/or ambient light is below a threshold.

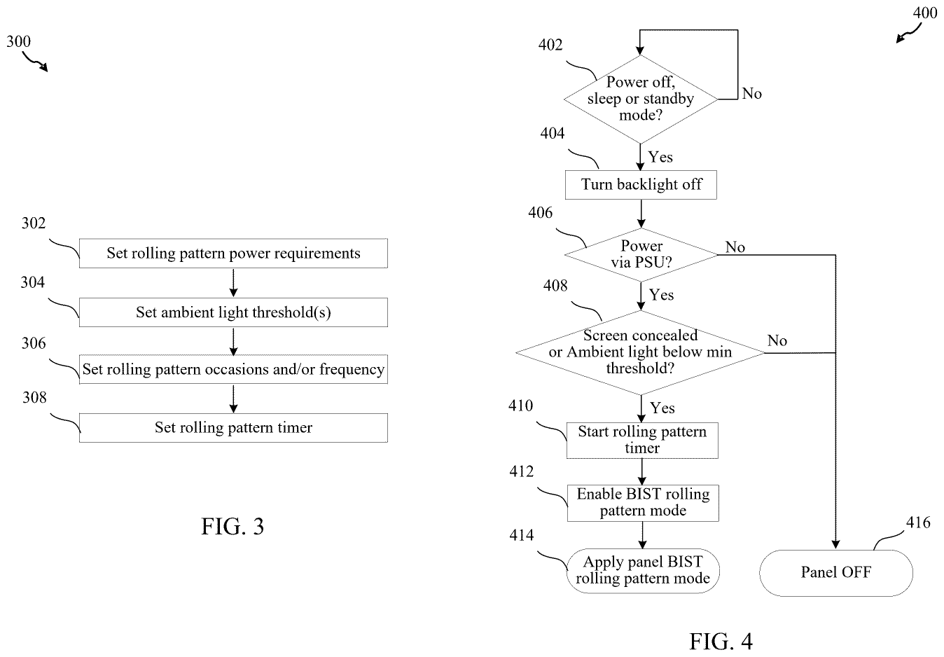

FIG. 3 illustrates an example of configuring variables for application of a concealed rolling pattern, according to an embodiment. As shown in FIG. 3, application of a rolling pattern BIST mode to perform display maintenance may be based on custom and/or default settings, automatic, manual, periodic, and/or event driven operation.

Embodiments disclosed herein and other embodiments may operate in accordance with example method 300. Method 300 comprises steps 302, 304, 306 and 308. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 3. In various implementations, steps may be added, removed, implemented in the alternative, e.g., in any combination or order. FIG. 3 is simply one of many possible embodiments. Embodiments may implement fewer, more or different steps.

As shown in FIG. 3, in step 302, power requirements may be set for a rolling pattern. Rolling pattern power requirements may be default or factory settings and/or customized settings set by a user. A user may indicate (e.g., in a user interface), for example, do not run a rolling pattern on battery power (e.g., only AC wall outlet power) or stop a rolling pattern when the battery reaches a threshold level (e.g., 80% battery remaining).

As shown in FIG. 3, in step 304, an ambient light threshold may be set. Ambient light threshold(s) may be default or factory settings and/or customized settings set by a user. A user may indicate (e.g., in a user interface), for example, that a rolling pattern may begin at a first ambient light threshold and stop at a second ambient light threshold. The first and second thresholds may be the same or different.

As shown in FIG. 3, in step 306, rolling pattern occasions and/or frequency may be set. Rolling pattern occasions and/or frequencies may be default or factory settings and/or customized settings set by a user. A user may indicate (e.g., in a user interface), for example, that a rolling pattern may run every day at 3 AM in the morning regardless of other settings or conditioned on one or more other settings.

As shown in FIG. 3, in step 308, a rolling pattern timer may be set. A rolling pattern timer may be a default or factory setting and/or a customized setting set by a user. A user may indicate (e.g., in a user interface), for example, that a rolling pattern may run for one hour each time it runs or a total of two hours per day. A setting may indicate for example, that if a rolling pattern runs for 20 minutes before being interrupted, that the timer starts at 40 minutes the next time the pattern runs on the same day.

FIG. 4 illustrates an example of applying a concealed rolling pattern, according to an embodiment. Embodiments disclosed herein and other embodiments may operate in accordance with example method 400. Method 400 comprises steps 402 to 416. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 4. In various implementations, steps may be added, removed, implemented in the alternative, e.g., in any combination or order. FIG. 4 is simply one of many possible embodiments. Embodiments may implement fewer, more or different steps.

As shown in FIG. 4, in step 402, a determination may be made whether a computing device is in a low power state (e.g., powered off, sleep standby modes). If so, the procedure may proceed to step 404. If not, the method may loop or wait to be triggered by a low power event. For example, as shown in FIG. 1, SCON 116 may be triggered to begin a display screen maintenance/rolling pattern procedure based on a low power event, which may be indicated by an operating system and/or power selection signal 132.

As shown in FIG. 4, in step 404, the backlight may be turned off. For example, as shown in FIG. 1, SCON 116 may send a backlight power disable signal 130 to backlight power switch 112, which will turn off power to backlight power conductor 122.

As shown in FIG. 4, in step 406, a determination may be made whether the computing device is receiving power. If not, the procedure may proceed to step 416 to turn off the display panel. If the computing device is powered by a power source, the procedure may continue to step 408. For example, as shown in FIG. 1, SCON 116 may check power detection signal 136 to determine whether computing device 100 is receiving power from an AC power source. SCON 116 may determine not to run a rolling pattern and, instead, send a disable signal via LCM power enable signal 128 to power switch 110 to turn off power to LCM 102.

As shown in FIG. 4, in step 408, a determination may be made whether the display/screen is concealed and/or whether ambient light is below a threshold. The example method may continue towards applying a rolling pattern in step 410 if display panel 104 is concealed or ambient light indicated by ALS 118 is below a threshold. The example method may turn power off to the display panel in step 416 if display panel 104 is not concealed and ambient light is above a threshold. For example, as shown in FIG. 1, SCON 116 may determine whether display panel 104 is covered (e.g., notebook lid closed) and/or determine whether ambient lighting signal 134 indicates ambient light is below a threshold. SCON 116 may proceed with rolling pattern if display panel 104 is concealed or if ambient light indicated by ALS 118 is below a threshold.

As shown in FIG. 4, in step 410, a rolling pattern timer may be started. For example, as shown in FIG. 1, SCON 116 may start a (e.g., internal) timer for application of a rolling pattern.

As shown in FIG. 4, in step 412, a BIST rolling pattern mode may be enabled. For example, as shown in FIG. 1, SCON 116 may enable BIST control signal 126.

As shown in FIG. 4, in step 414, a BIST rolling pattern mode may be applied to the display panel. For example, as shown in FIG. 1, TCON 108 may apply a BIST rolling pattern mode to display panel 104. FIG. 2 shows an example of a rolling pattern that may be applied by TCON 108.

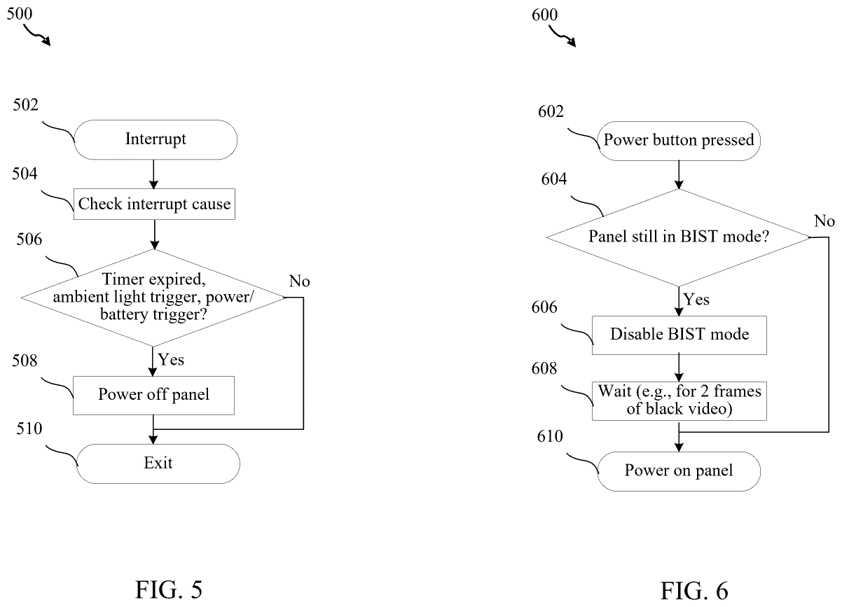

FIG. 5 illustrates an example of interrupting a concealed rolling pattern, according to an embodiment. Embodiments disclosed herein and other embodiments may operate in accordance with example method 500. Method 500 comprises steps 502 to 510. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 5. In various implementations, steps may be added, removed, implemented in the alternative, e.g., in any combination or order. FIG. 5 is simply one of many possible embodiments. Embodiments may implement fewer, more or different steps.

As shown in FIG. 5, in step 502, an interrupt may be received or generated. For example, as shown in FIG. 1, SCON 116 may generate or receive an interrupt flag.

As shown in FIG. 5, in step 504, the cause of the interrupt may be analyzed. For example, as shown in FIG. 1, SCON 116 may determine the source and/or cause of an interrupt.

As shown in FIG. 5, in step 506, a determination may be made whether the cause of the interrupt is expiration of a rolling pattern timer, ambient light increasing above a threshold, and/or loss of power source or battery below a threshold. For example, as shown in FIG. 1, SCON 116 may determine whether the cause of the interrupt is expiration of a rolling pattern timer, ambient light increasing above a threshold, and/or loss of power source or an indication that remaining battery power is at or below a threshold.

As shown in FIG. 5, in step 508, the display panel may be powered off if the cause of the interrupt is expiration of a rolling pattern timer, ambient light increasing above a threshold, and/or loss of power source or an indication that remaining battery power is at or below a threshold. Otherwise, the interrupt routine may exit at step 510. For example, as shown in FIG. 1, SCON 116 may disable BIST control signal 126 and disable LCM power enable signal 128 if the cause of the interrupt is expiration of a rolling pattern timer, ambient light increasing above a threshold, and/or loss of power source or an indication that remaining battery power of computing device 100 is at or below a threshold. Otherwise, SCON 116 may exit the interrupt routine.

FIG. 6 illustrates an example of powering-on a display with a delay during a concealed rolling pattern to maintain concealment, according to an embodiment. Embodiments disclosed herein and other embodiments may operate in accordance with example method 600. Method 600 comprises steps 602 to 610. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 6. In various implementations, steps may be added, removed, implemented in the alternative, e.g., in any combination or order. FIG. 6 is simply one of many possible embodiments. Embodiments may implement fewer, more or different steps.

As shown in FIG. 6, in step 602, a power button may be pressed. For example, as shown in FIG. 1, SCON 116 may receive an indication via power selection signal 132 that a user pressed power button switch 114 to turn on computing device 100.

As shown in FIG. 6, in step 604, a determination may be made whether the display panel is still in BIST rolling pattern mode. For example, as shown in FIG. 1, SCON 116 may determine whether TCON 108 is applying a rolling pattern to display panel 104 while computing device is in a low power mode. If TCON 108 is applying a rolling pattern to display panel 104, SCON 116 may proceed to step 606 for a delayed power on of backlight module 106. By delaying power on of backlight module 106 in such a scenario, the application of the rolling pattern can be concealed from the user. If TCON 108 is not applying a rolling pattern to display panel 104, SCON 116 may proceed to step 610 to turn on backlight power without delay.

As shown in FIG. 6, in step 606, BIST mode may be disabled. For example, as shown in FIG. 1, SCON 116 may disable BIST control signal 126. TCON 108 may stop applying a rolling pattern to display panel 104.

As shown in FIG. 6, in step 608, there may be a delay or wait time. For example, as shown in FIG. 1, TCON 108 may be configured to apply one or more (e.g., a minimum of two) black screens to display panel 104.

As shown in FIG. 6, in step 610, the display panel may be powered on. For example, as shown in FIG. 1, SCON 116 may (e.g., after a delay for TCON 108 to apply two black screens to display panel 108) enable backlight power enable signal 130 to indicate backlight power switch 112 provide power to display panel 104 via backlight power conductor 122.

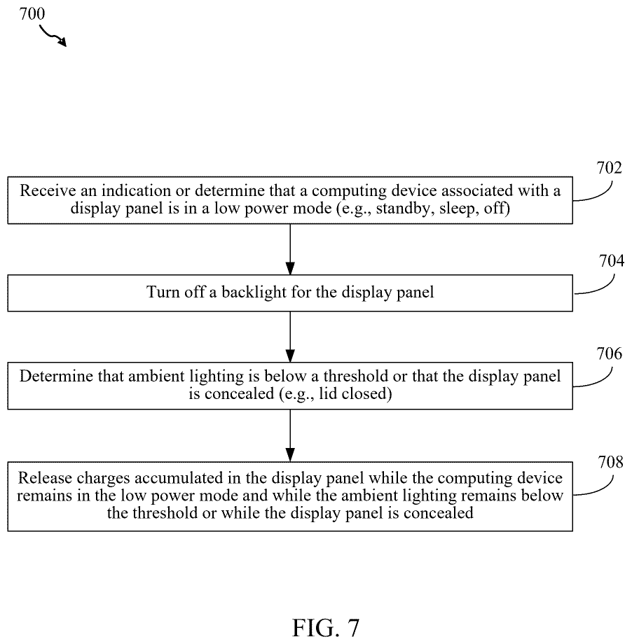

FIG. 7 illustrates a flowchart of an example method for reducing screen flicker using a concealed rolling pattern, according to an example embodiment. Embodiments disclosed herein and other embodiments may operate in accordance with example method 700. Method 700 comprises steps 702, 704, 706 and 708. However, other embodiments may operate according to other methods. Other structural and operational embodiments will be apparent to persons skilled in the relevant art(s) based on the foregoing discussion of embodiments. No steps are required unless expressly indicated or inherently required. No order of steps is required unless expressly indicated or inherently required. There is no requirement that a method embodiment implement all of the steps illustrated in FIG. 7. In various implementations, steps may be added, removed, implemented in the alternative, e.g., in any combination or order. FIG. 7 is simply one of many possible embodiments. Embodiments may implement fewer, more or different steps.

As shown in FIG. 7, in step 702, an indication may be received or a determination may be made that a computing device associated with a display panel is in a low power mode (e.g., standby, sleep, off). For example, as shown in FIG. 1, SCON 116 may determine or may receive an indication (e.g., from power button switch 114) that computing device 100 is in a low power mode.

As shown in FIG. 7, in step 704, a backlight for the display panel may be turned off. For example, as shown in FIG. 1, SCON 116 may send a backlight power disable signal 130 to backlight power switch 112, which will turn off power to backlight power conductor 122.

As shown in FIG. 7, in step 706, a determination may be made that ambient lighting is below a threshold or that the display panel is concealed (e.g., lid closed). For example, as shown in FIG. 1, SCON 116 may determine whether display panel 104 is covered (e.g., notebook lid closed) and/or determine whether ambient lighting signal 134 indicates ambient light is below a threshold.

As shown in FIG. 7, in step 708, charges accumulated in the display panel may be released (e.g., by a rolling pattern) while the computing device remains in the low power mode and while the ambient lighting remains below the threshold or while the display panel is concealed. For example, as shown in FIG. 1, TCON 108 may apply a BIST rolling pattern mode to display panel 104 while SCON 116 determines or receives indications that the computing device remains in the low power mode and while the ambient lighting remains below the threshold or while the display panel is concealed. FIG. 2 shows an example of a rolling pattern that may be applied by TCON 108.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 8. FIG. 8 shows a block diagram of an exemplary computing environment 800 that includes a computing device 802. Computing device 802 is an example of example computing device 100 shown FIG. 1, which may include one or more of the components of computing device 802. In some embodiments, computing device 802 is communicatively coupled with devices (not shown in FIG. 8) external to computing environment 800 via network 804. Network 804 comprises one or more networks such as local area networks (LANs), wide area networks (WANs), enterprise networks, the Internet, etc., and may include one or more wired and/or wireless portions. Network 804 may additionally or alternatively include a cellular network for cellular communications. Computing device 802 is described in detail as follows

Computing device 802 can be any of a variety of types of computing devices. For example, computing device 802 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses, etc.), or other type of mobile computing device. Computing device 802 may alternatively be a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 890. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and any combination of the components may be present in a particular embodiment. These components of computing device 802 are described as follows.

A single processor 810 (e.g., central processing unit (CPU), microcontroller, a microprocessor, signal processor, ASIC (application specific integrated circuit), and/or other physical hardware processor circuit) or multiple processors 810 may be present in computing device 802 for performing such tasks as program execution, signal coding, data processing, input/output processing, power control, and/or other functions. Processor 810 may be a single-core or multi-core processor, and each processor core may be single-threaded or multithreaded (to provide multiple threads of execution concurrently). Processor 810 is configured to execute program code stored in a computer readable medium, such as program code of operating system 812 and application programs 814 stored in storage 820. Operating system 812 controls the allocation and usage of the components of computing device 802 and provides support for one or more application programs 814 (also referred to as “applications” or “apps”). Application programs 814 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) that may be present to communicatively couple processor 810 to various other components of computing device 802, although in other embodiments, an alternative bus, further buses, and/or one or more individual signal lines may be present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 890, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 822 may include main memory and may be separate from or fabricated in a same integrated circuit as processor 810. As shown in FIG. 8, non-removable memory 822 stores firmware 818, which may be present to provide low-level control of hardware. Examples of firmware 818 include BIOS (Basic Input/Output System, such as on personal computers) and boot firmware (e.g., on smart phones). Removable memory 824 may be inserted into a receptacle of or otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 890 may be present that are internal and/or external to a housing of computing device 802 and may or may not be removable. Examples of storage device 890 include a hard disk drive, a SSD, a thumb drive (e.g., a USB (Universal Serial Bus) flash drive), or other physical storage device.

One or more programs may be stored in storage 820. Such programs include operating system 812, one or more application programs 814, and other program modules and program data. Examples of such application programs may include, for example, computer program logic (e.g., computer program code/instructions) for implementing one or more of TCON 108, SCON 116, etc., along with any components and/or subcomponents thereof, as well as the flowcharts/flow diagrams (e.g., methods 300, 400, 500, 600, and 700) described herein, including portions thereof, and/or further examples described herein.

Storage 820 also stores data used and/or generated by operating system 812 and application programs 814 as application data 816. Examples of application data 816 include web pages, text, images, tables, sound files, video data, and other data, which may also be sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 802 through one or more input devices 830 and may receive information from computing device 802 through one or more output devices 850. Input device(s) 830 may include one or more of touch screen 832, microphone 834, camera 836, physical keyboard 838 and/or trackball 840 and output device(s) 850 may include one or more of speaker 852 and display 854. Each of input device(s) 830 and output device(s) 850 may be integral to computing device 802 (e.g., built into a housing of computing device 802) or external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 may display information, as well as operating as touch screen 832 by receiving user commands and/or other information (e.g., by touch, finger gestures, virtual keyboard, etc.) as a user interface. Any number of each type of input device(s) 830 and output device(s) 850 may be present, including multiple microphones 834, multiple cameras 836, multiple speakers 852, and/or multiple displays 854.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). Wireless modem 860 may also or alternatively include other radio-based modem types, such as a Bluetooth modem 864 (also referred to as a “Bluetooth device”) and/or Wi-Fi 862 modem (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.15.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and may receive power from a battery internal to computing device 802, and/or from a power cord plugged into a power port of computing device 802 (e.g., a USB port, an A/C power port). LI receiver 884 may be used for location determination of computing device 802 and may include a satellite navigation receiver such as a Global Positioning System (GPS) receiver or may include other type of location determiner configured to determine location of computing device 802 based on received information (e.g., using cell tower triangulation, etc.). Accelerometer 886 may be present to determine an orientation of computing device 802.

Note that the illustrated components of computing device 802 are not required or all-inclusive, and fewer or greater numbers of components may be present as would be recognized by one skilled in the art. For example, computing device 802 may also include one or more of a gyroscope, barometer, proximity sensor, ambient light sensor, digital compass, etc. Processor 810 and memory 856 may be co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein may be stored in storage 820 and executed by processor 810.

In some embodiments, server infrastructure 870 may be present in computing environment 800 and may be communicatively coupled with computing device 802 via network 804. Server infrastructure 870, when present, may be a network-accessible server set (e.g., a cloud-based environment or platform). As shown in FIG. 8, server infrastructure 870 includes clusters 872. Each of clusters 872 may comprise a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. Any of nodes 874 may be a storage node that comprises a plurality of physical storage disks, SSDs, and/or other physical storage devices that are accessible via network 804 and are configured to store data associated with the applications and services managed by nodes 874. For example, as shown in FIG. 8, nodes 874 may store application data 878.

Each of nodes 874 may, as a compute node, comprise one or more server computers, server systems, and/or computing devices. For instance, a node 874 may include one or more of the components of computing device 802 disclosed herein. Each of nodes 874 may be configured to execute one or more software applications (or “applications”) and/or services and/or manage hardware resources (e.g., processors, memory, etc.), which may be utilized by users (e.g., customers) of the network-accessible server set. For example, as shown in FIG. 8, nodes 874 may operate application programs 876. In an implementation, a node of nodes 874 may operate or comprise one or more virtual machines, with each virtual machine emulating a system architecture (e.g., an operating system), in an isolated manner, upon which applications such as application programs 876 may be executed.

In an embodiment, one or more of clusters 872 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 872 may be a datacenter in a distributed collection of datacenters. In embodiments, exemplary computing environment 800 comprises part of a cloud-based platform such as Amazon Web Services® of Amazon Web Services, Inc. or Google Cloud Platform™ of Google LLC, although these are only examples and are not intended to be limiting.

In an embodiment, computing device 802 may access application programs 876 for execution in any manner, such as by a client application and/or a browser at computing device 802. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 802 may additionally and/or alternatively synchronize copies of application programs 814 and/or application data 816 to be stored at network-based server infrastructure 870 as application programs 876 and/or application data 878. For instance, operating system 812 and/or application programs 814 may include a file hosting service client configured to synchronize applications and/or data stored in storage 820 at network-based server infrastructure 870.

In some embodiments, on-premises servers 892 may be present in computing environment 800 and may be communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 may be shared by on-premises servers 892 between computing devices of the organization, including computing device 802 (when part of an organization) through a local network of the organization, and/or through further networks accessible to the organization (including the Internet). Furthermore, on-premises servers 892 may serve applications such as application programs 896 to the computing devices of the organization, including computing device 802. Accordingly, on-premises servers 892 may include storage 894 (which includes one or more physical storage devices such as storage disks and/or SSDs) for storage of application programs 896 and application data 898 and may include one or more processors for execution of application programs 896. Still further, computing device 802 may be configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 may be used to implement systems, clients, or devices, or components/subcomponents thereof, disclosed elsewhere herein. In other embodiments, a combination of computing device 802, network-based server infrastructure 870, and/or on-premises servers 892 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 814) may be stored in storage 820. Such computer programs may also be received via wired interface(s) 880 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Further Example Embodiments

Methods, systems and computer program products are provided for reducing screen flicker using a concealed rolling pattern. Field application of a concealable rolling pattern (e.g., an alternating electric field) to cause liquid crystal module (LCM) pixels to display alternating black and white patterns may increase mobile ion diffusion, reducing screen flickering and image burn-in, which may be more common when static images are refreshed less frequently. In response to an indication that a computing device associated with the display panel is in a low power mode (e.g., standby, sleep, off), a computing device (e.g., a system controller interfaced with an LCM) may turn off the backlight for the display panel, determine that ambient lighting is below a threshold or that the display panel is concealed (e.g., lid closed), and release charges accumulated in the display panel (e.g., using the rolling pattern) while the computing device remains in a low power mode and while the ambient lighting remains below the threshold or while the display panel is concealed. The release of charges accumulated in the display panel may be stopped based on detection of one or more events, such as transitioning from the low power mode to a full power mode; receiving an indication that a timer for application of the rolling pattern has expired; determining that ambient light is above the threshold while the display panel is not concealed (e.g., lid not closed); or detecting an absence of a power supply or that a battery for the computing device is below a threshold. Upon receiving an indication to transition from the low power mode to a full power mode, a computing device may stop application of the rolling pattern to pixels in the display panel; and delay powering on the backlight after stopping application of the rolling pattern to pixels in the display panel. The delay may comprise a time for application of at least two frames of black video to the display panel.

In examples, a computing system may comprise a liquid crystal module (LCM) comprising a display panel, a timing controller (TCON), and a backlight; an ambient light sensor (ALS) configured to sense ambient light; and a system controller (SCON) configured to: receive an indication that or determine that the computing device is in a low power mode (e.g., standby, sleep, off); turn off the backlight; determine that ambient lighting sensed by the ALS is below a threshold or that the LCM is concealed (e.g., lid closed); and control the TCON to apply a rolling pattern to pixels in the display panel (e.g., to release accumulated charges) while the computing device remains in a low power mode and while the ambient lighting remains below the threshold or while the display panel is concealed.

In examples, the SCON may be configured to control the TCON to apply the rolling pattern to pixels in the display panel while the ambient lighting remains below the threshold.

In examples, the SCON may be configured to control the TCON to apply the rolling pattern to pixels in the display panel while the display panel is concealed (e.g., lid closed).

In examples, the SCON may be configured to control the TCON to apply the rolling pattern to pixels in the display panel while the display panel (e.g., and computing device) is powered by a power supply.

In examples, the SCON may be configured to stop the TCON application of the rolling pattern to pixels in the display panel (e.g., or power off the panel) based on at least one of the following events: receiving an indication that a timer for application of the rolling pattern has expired; determining that ambient light sensed by the ALS is above the threshold while the display panel is not concealed; or detecting an absence of a power supply or that a battery for the computing device is below a threshold.

In examples, the SCON may be further configured to: receive an indication (e.g., from power switch) to transition from the low power mode to a full power mode; control the TCON to stop application of the rolling pattern to pixels in the display panel; and delay powering on the backlight after indicating to the TCON to stop application of the rolling pattern to pixels in the display panel.

In examples, the delay may comprise a time for the TCON to provide at least two frames of black video to the display panel.

In examples, the TCON may be configured to conserve power by refreshing a static image on the display panel at a reduced frequency that contributes to the charges accumulated in the display panel.

In examples, a computer-implemented method may comprise receiving an indication that a computing device associated with a display panel is in a low power mode; turning off a backlight for the display panel; determining that ambient lighting is below a threshold or that the display panel is concealed; and releasing charges accumulated in the display panel while the computing device remains in the low power mode and while the ambient lighting remains below the threshold or while the display panel is concealed.

In examples, the releasing of the charges accumulated in the display panel may comprise applying a rolling pattern that induces an alternating electric field in pixels of the display panel.

In examples, the charges accumulated in the display panel may be released while the ambient lighting remains below the threshold.

In examples, the charges accumulated in the display panel may be released while the display panel is concealed.

In examples, the charges accumulated in the display panel may be released while the display panel is powered by a power supply.

In examples, the computer-implemented method may (e.g., further) comprise stopping the release of charges accumulated in the display panel based on detection of at least one of the following events: transitioning from the low power mode to a full power mode; receiving an indication that a timer for releasing the charges accumulated in the display panel has expired; determining that the ambient light is above the threshold while the display panel is not concealed; or detecting an absence of a power supply or that a battery for the computing device is below a threshold.

In examples, the computer-implemented method may (e.g., further) comprise receiving an indication or determining to transition from the low power mode to a full power mode; stopping the release of charges accumulated in the display panel; and delaying powering on the backlight by a delay after stopping the release of charges accumulated in the display panel.

In examples, the delay may comprise a time for application of at least two frames of black video to the display panel.

In examples, a computer-readable storage medium may have program instructions recorded thereon that, when executed by a processing circuit, perform a method. The method may comprise receiving an indication that a computing device associated with a display panel is in a low power mode; turning off a backlight for the display panel; determining that ambient lighting is below a threshold or that the display panel is concealed; and releasing charges accumulated in the display panel while the computing device remains in the low power mode and while the ambient lighting remains below the threshold or while the display panel is concealed.

In examples, the method may (e.g., further) comprise stopping the release of charges accumulated in the display panel based on detection of at least one of the following events: transitioning from the low power mode to a full power mode; receiving an indication that a timer for releasing the charges accumulated in the display panel has expired; determining that the ambient light is above the threshold while the display panel is not concealed; or detecting an absence of a power supply or that a battery for the computing device is below a threshold.

In examples, the method may (e.g., further) comprise receiving an indication or determining to transition from the low power mode to a full power mode; stopping the release of charges accumulated in the display panel; and delaying powering on the backlight by a delay after stopping the release of charges accumulated in the display panel.

In examples, the delay may comprise a time for application of at least two frames of black video to the display panel.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an example embodiment of the disclosure, are understood to mean that the condition or characteristic is defined to within tolerances that are acceptable for operation of the embodiment for an application for which it is intended.

If the performance of an operation is described herein as being “based on” one or more factors, it is to be understood that the performance of the operation may be based solely on such factor(s) or may be based on such factor(s) along with one or more additional factors. Thus, as used herein, the term “based on” should be understood to be equivalent to the term “based at least on.”

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computing device, comprising:
a liquid crystal module (LCM) comprising a display panel, a timing controller (TCON), and a backlight;
an ambient light sensor (ALS) configured to sense ambient light; and
a system controller (SCON) configured to:
receive an indication that or determine that the computing device is in a low power mode;
turn off the backlight;
determine that ambient lighting sensed by the ALS is below a threshold or that the LCM is concealed; and
control the TCON to apply a rolling pattern to pixels in the display panel while the computing device remains in a low power mode and while the ambient lighting remains below the threshold or while the display panel is concealed.

2. The computing device of claim 1, wherein the SCON is configured to control the TCON to apply the rolling pattern to pixels in the display panel while the ambient lighting remains below the threshold.

3. The computing device of claim 1, wherein the SCON is configured to control the TCON to apply the rolling pattern to pixels in the display panel while the display panel is concealed.

4. The computing device of claim 1, wherein the SCON is configured to control the TCON to apply the rolling pattern to pixels in the display panel while the display panel is powered by a power supply.

5. The computing device of claim 1, wherein the SCON is configured to stop the TCON application of the rolling pattern to pixels in the display panel based on at least one of the following events:
receiving an indication that a timer for application of the rolling pattern has expired;
determining that ambient light sensed by the ALS is above the threshold while the display panel is not concealed; or
detecting an absence of a power supply or that a battery for the computing device is below a threshold.

6. The computing device of claim 1, wherein the SCON is further configured to:
receive an indication to transition from the low power mode to a full power mode;
control the TCON to stop application of the rolling pattern to pixels in the display panel; and
delay powering on the backlight after indicating to the TCON to stop application of the rolling pattern to pixels in the display panel.

7. The computing device of claim 6, wherein the delay comprises:
a time for the TCON to provide at least two frames of black video to the display panel.

8. The computing device of claim 1, wherein the TCON is configured to conserve power by refreshing a static image on the display panel at a reduced frequency that contributes to the charges accumulated in the display panel.

9. A computer-implemented method comprising:
receiving an indication or determining that a computing device associated with a display panel is in a low power mode;
turning off a backlight for the display panel;
determining that ambient lighting is below a threshold or that the display panel is concealed; and
releasing charges accumulated in the display panel while the computing device remains in the low power mode and while the ambient lighting remains below the threshold or while the display panel is concealed.

10. The computer-implemented method of claim 9, wherein the releasing of the charges accumulated in the display panel comprises:
applying a rolling pattern that induces an alternating electric field in pixels of the display panel.

11. The computer-implemented method of claim 9, wherein the charges accumulated in the display panel are released while the ambient lighting remains below the threshold.

12. The computer-implemented method of claim 9, wherein the charges accumulated in the display panel are released while the display panel is concealed.

13. The computer-implemented method of claim 9, wherein the charges accumulated in the display panel are released while the display panel is powered by a power supply.

14. The computer-implemented method of claim 9, further comprising:
stopping the release of charges accumulated in the display panel based on detection of at least one of the following events:
transitioning from the low power mode to a full power mode;
receiving an indication that a timer for releasing the charges accumulated in the display panel has expired;
determining that the ambient light is above the threshold while the display panel is not concealed; or
detecting an absence of a power supply or that a battery for the computing device is below a threshold.

15. The computer-implemented method of claim 9, further comprising:
receiving an indication or determining to transition from the low power mode to a full power mode;
stopping the release of charges accumulated in the display panel; and
delaying powering on the backlight by a delay after stopping the release of charges accumulated in the display panel.

16. The computer-implemented method of claim 15, wherein the delay comprises:
a time for application of at least two frames of black video to the display panel.

17. A computer-readable storage medium having program instructions recorded thereon that, when executed by a processing circuit, perform a method comprising:
receiving an indication that a computing device associated with a display panel is in a low power mode;
turning off a backlight for the display panel;
determining that ambient lighting is below a threshold or that the display panel is concealed; and
releasing charges accumulated in the display panel while the computing device remains in the low power mode and while the ambient lighting remains below the threshold or while the display panel is concealed.

18. The computer-readable storage medium of claim 17, the method further comprising:
stopping the release of charges accumulated in the display panel based on detection of at least one of the following events:
transitioning from the low power mode to a full power mode;
receiving an indication that a timer for releasing the charges accumulated in the display panel has expired;
determining that the ambient light is above the threshold while the display panel is not concealed; or
detecting an absence of a power supply or that a battery for the computing device is below a threshold.

19. The computer-readable storage medium of claim 17, the method further comprising:
receiving an indication or determining to transition from the low power mode to a full power mode;
stopping the release of charges accumulated in the display panel; and
delaying powering on the backlight by a delay after stopping the release of charges accumulated in the display panel.

20. The computer-readable storage medium of claim 19, wherein the delay comprises:
a time for application of at least two frames of black video to the display panel.
